(19) United States
(12) Patent Application Publication
(10) Pub. No.: US 2020/0134699 A1
(43) Pub. Date: Apr. 30, 2020

(54) System and Apparatus for Ordering a Product and/or Service

(71) Applicant: Michael MOROZOV, Vaughan (CA)

(72) Inventor: Michael MOROZOV, Vaughan (CA)

(21) Appl. No.: 16/169,394

(22) Filed: Oct. 24, 2018

(51) Int. Cl. G06Q 30/06; G06Q 20/32

(52) U.S. Cl. CPC G06Q 30/0635; G06Q 20/325; G06Q 30/0641

(57) ABSTRACT

There is provided a system and/or method for ordering or re-ordering, as needed, a product and/or service, and which advantageously may require fewer steps than traditional ordering or re-ordering. The system includes a plurality of signal receiver-emitters configured to receive position and time stamp data from orbiting satellites, and which transmit an associated predetermined signal; an interrupting device selectively operable via an associated control mechanism to effect at least one preselected interruption in the associated predetermined signal; and a host receiver configured to receive a plurality of the associated predetermined signals and to detect the at least one preselected interruption in the associated predetermined signals. The invention further provides that the host receiver is operable, upon detecting the at least one preselected interruption, to output a control signal for initiating delivery of the product and/or service to a customer in accordance with pre-stored order information data.

### SCOPE OF THE INVENTION

The present invention generally relates to an ordering system and in particular to a system that includes GPS enabled apparatuses that facilitate the ordering of a variety of products and/or services.

### BACKGROUND OF THE INVENTION

In order to maintain a household or business in proper working order, there exists a number of actions that must be taken at regular intervals in order to maintain an adequate supply of consumable materials/products; or alternatively, to ensure the proper functioning of machines or equipment that are used in the daily running of the household or business.

A hair salon may, by way of example, require regular maintenance and servicing of its commercial grade hair dryers or perm machines. A homeowner may, for example, require regular refilling of his/her laundry detergent. A car owner may, by way of further example, require his/her windows cleaned on a regular basis.

The present invention relates to a system and apparatus suitable for ordering and re-ordering supplies or services whenever the need arises; and which advantageously may require fewer steps than traditional ordering/re-ordering. Through use of a preferred embodiment of the invention, for example, a user may advantageously order/re-order supplies or services by simply pushing a button. In an alternate embodiment, the system and apparatus may also function as a means for ordering emergency services in real-time, such as for example, ambulance services, police services or firefighter services.

There exists in the art Wi-Fi enabled devices that, similarly, may be used to order/re-order products through the pushing of a button. These devices, however, generally involve a significant amount of setup, and require a working Wi-Fi connection at all times in order to function. In contrast, the system and apparatus of the present invention may advantageously function in non-Wi-Fi enabled environments, and require limited setup time.

### SUMMARY OF THE INVENTION

The Inventor has recognized the inherent problems and lack in the art and observed that there is a need for a new system and apparatus for ordering products and/or services. In one non-limiting aspect, the present invention provides a system and apparatus for ordering a product and/or service through use of associated predetermined signals having a unique signature and incorporating at least one preselected signal anomaly, which corresponds to an interruption in the signal having a predetermined duration or a predetermined pattern and pattern duration, either of which having been pre-registered with a host receiver as directly identifying the product and/or service being ordered. In a further non-limiting aspect, the associated predetermined signals of the present invention include GPS coordinates of the relevant ordering apparatus(es).

The applicant has appreciated that use of the aforementioned system and apparatus(es), in a preferred embodiment, may advantageously allow for a product and/or service to be ordered by a user from one or more remote locations, and without requiring a Wi-Fi connection.

In one aspect, the invention provides a system for ordering a product and/or service, the system including: a plurality of signal receiver-emitters, each of the signal receiver-emitters being configured to receive position and time stamp data from orbiting GPS satellites, and/or to transmit an associated predetermined signal having a unique signature. Each of the signal receiver-emitters including: an interrupting device and associated control mechanism, the interrupting device being selectively operable via the control mechanism to effect at least one preselected signal anomaly in the associated predetermined signal, the at least one preselected signal anomaly including a preselected interruption of a predetermined duration and/or occurring in a predetermined pattern for a predetermined pattern duration. The system further including a host receiver configured to receive a plurality of the associated predetermined signals, the host receiver including: a communication unit; a signal anomaly detection unit configured to detect the at least one preselected signal anomaly in the associated predetermined signals; and/or a physical memory having stored thereon reference data identifying the unique signature of each of the associated predetermined signals, customer information data correlated to each unique signature of the associated predetermined signals, and/or order information data correlated to the predetermined duration and/or predetermined pattern and pattern duration of the preselected interruption of each of the at least one preselected signal anomalies in each of the associated predetermined signals; wherein the signal anomaly detection unit of the host receiver is operable to monitor the associated predetermined signals for each of the at least one preselected signal anomalies and, upon detecting the at least one preselected signal anomaly, to instruct the communication unit to output a control signal for initiating delivery of the product and/or service to a customer in accordance with the order information data.

In further aspect, the invention provides an apparatus for ordering a product and/or service, including: a signal receiver-emitter configured to transmit periodic signal updates to a host server, the host server including a signal anomaly detection unit and/or being located at a remote fulfilment centre; and an interrupting device having an associated control mechanism, the interrupting device being configured to interrupt the periodic signal updates for a predetermined duration and/or in a predetermined pattern over a predetermined pattern duration, when the control mechanism is activated by a user; wherein the signal anomaly detection unit of the host server is configured to monitor the periodic signal updates for any interruptions in the periodic signal updates and/or to identify any of the interruptions attributable to the interrupting device and/or occurring for the predetermined duration and/or in the predetermined pattern over the predetermined pattern duration; and wherein data representing the interruptions occurring for the predetermined duration and/or in the predetermined pattern over the predetermined pattern duration has been pre-registered with the fulfilment center as identifying the product and/or service for order.

In addition to the foregoing, the invention may also provide one or more of the following additional and non-limiting aspects.

In one aspect, the system of the hereinafter or the hereinbefore may also provide that at least one of the associated predetermined signals includes the position and time stamp data from the orbiting GPS satellites; the host receiver further includes a processing unit configured to analyze the position and time stamp data in order to determine location information of the signal receiver-emitters, the location information including GPS coordinates of the signal receiver-emitters; the customer information data includes at least one of a customer name, a customer address and a customer vehicle identifier; and/or the order information data includes instructions to deliver the product and/or service to the customer at one of the customer address or a customer vehicle located at the GPS coordinates, the customer vehicle being identifiable by way of the customer vehicle identifier.

In a further aspect, the system of the hereinafter or the hereinbefore may also provide that at least one of the signal receiver-emitters further includes a processor configured to analyze the position and time stamp data from the orbiting GPS satellites in order to determine location information of the signal receiver-emitters, the location information including GPS coordinates of the signal receiver-emitters; at least one of the plurality of associated predetermined signals includes the location information; the customer information data includes at least one of a customer name, a customer address and a customer vehicle identifier; and/or the order information data includes instructions to deliver the product and/or service to the customer at one of the customer address or a customer vehicle located at the GPS coordinates, the customer vehicle being identifiable by way of the customer vehicle identifier.

In another aspect, the system of the hereinafter or the hereinbefore may also provide that at least one of the associated predetermined signals consists of a transient signal that is transmitted at predetermined equal intervals of time; the reference data further includes data identifying the at least one associated predetermined signals by way of the predetermined equal intervals of time; the preselected interruption of the at least one preselected signal anomaly in the at least one associated predetermined signals has the predetermined duration which spans at least two of the predetermined equal intervals of time, and/or occurs in the predetermined pattern that consists of extending the predetermined equal intervals of time by a preselected amount over the predetermined pattern duration; and/or the order information data specifically correlates each of the predetermined duration and/or predetermined pattern and pattern duration of the at least one preselected signal anomaly in the at least one associated predetermined signals to a distinct order command which includes instructions to deliver the product and/or service in a manner and quantity that has been preselected by the customer, and/or to bill the customer for the product and/or service in accordance with pre-registered billing instructions.

In a further aspect, the system of the hereinafter or the hereinbefore may also provide that at least one of the associated predetermined signals consists of a constant signal that when undisturbed is transmitted without any substantial interruptions; the preselected interruption of the at least one preselected signal anomaly in the at least one associated predetermined signals has the predetermined duration and/or occurs in the predetermined pattern that consists of interrupting the constant signal in a predetermined pulsed pattern over the predetermined pattern duration; and/or the order information data specifically correlates each of the predetermined duration and/or predetermined pattern and pattern duration of the at least one preselected signal anomaly in the at least one associated predetermined signals to a distinct order command which includes instructions to deliver the product and/or service in a manner and quantity that has been preselected by the customer, and/or to bill the customer for the product and/or service in accordance with pre-registered billing instructions.

In another aspect, the system of the hereinafter or the hereinbefore may also provide that the interrupting device is further configured, when activated via the control mechanism, to repeat the at least one preselected signal anomaly in the associated predetermined signal a preselected number of times and/or over a preselected period of time; and/or the signal anomaly detection unit of the host receiver is further configured to ignore any duplicate detections of the at least one preselected signal anomaly in the associated predetermined signal which occurs in a predetermined window of time, so as to prevent any unwanted duplication in customer orders.

In a further aspect, the system of the hereinafter or the hereinbefore may also provide that upon detecting a first occurrence of the at least one preselected signal anomaly in any of the predetermined windows of time by the signal anomaly detection unit, the communication unit is configured to assign an order number to the control signal, wherein the order number increases by a factor of 1 each time a further occurrence of the at least one preselected signal anomaly is detected in a new predetermined window of time; the customer information data further includes at least one of a customer e-mail address and a customer phone number; and/or the control signal further initiates immediate delivery of an order confirmation receipt, which includes the order number, to the customer at the customer e-mail address or customer phone number.

In another aspect, the system of the hereinafter or the hereinbefore may also provide that the host receiver is geographically remote from at least one of the signal receiver-emitters; and/or the control signal further initiates delivery of the product and/or service to the customer by transmitting a command for dispatch of the product and/or service to one of a plurality of remote fulfilment centres, the one remote fulfilment centre being selected based on a variety of factors including current availability of the product and/or service at the one remote fulfilment centre and/or geographic proximity of the one remote fulfilment centre to the customer address and/or to the GPS coordinates.

In a further aspect, the system of the hereinafter or the hereinbefore may also provide that when the signal anomaly detection unit detects a first occurrence of the at least one preselected signal anomaly in any of the predetermined windows of time, the host receiver is configured to open a new ticket, corresponding to a new customer order; upon receiving the command for dispatch of the product and/or service, the one remote fulfilment centre transmits a confirmation receipt to the host receiver; and/or upon receiving the confirmation receipt, the host receiver is further configured to mark the new ticket as having been completed.

In another aspect, the system of the hereinafter or the hereinbefore may also provide that at least one of the associated predetermined signals includes a digital signal and is transmittable over a cellular communications network.

In a further aspect, the system of the hereinafter or the hereinbefore may also provide that at least one of the associated predetermined signals is transmittable by radio.

In another aspect, the system of the hereinafter or the hereinbefore may also provide that the control mechanism is a push button.

In a further aspect, the system of the hereinafter or the hereinbefore may also provide that the interrupting device is associated with at least one of the control mechanisms, the interrupting device being selectively operable via each of the at least one control mechanism to effect a distinct preselected signal anomaly in the associated predetermined signal; and/or the order information data specifically correlates the predetermined duration and/or predetermined pattern and pattern duration of each distinct preselected signal anomaly to a distinct product and/or service for order.

In another aspect, the system of the hereinafter or the hereinbefore may also provide that at least one of the signal receiver-emitters is configured to transmit the associated predetermined signal over a wi-fi or bluetooth connection in a signal burst which includes the at least one preselected signal anomaly, when the interrupting device is activated via the control mechanism; the customer information data includes at least one of a customer name and a customer address; and/or the order information data specifically correlates the predetermined duration and/or predetermined pattern and pattern duration of the at least one preselected signal anomaly to a distinct product and/or service for order, and includes instructions to deliver the distinct product and/or service to the customer address.

In a further aspect, the apparatus of the hereinafter or the hereinbefore may further provide that the signal receiver-emitter is configured to receive position and time stamp data from orbiting GPS satellites.

In a further aspect, the apparatus of the hereinafter or the hereinbefore may further provide a processor configured to analyze the position and time stamp data to determine a location of the apparatus; and/or wherein the periodic signal updates include location information including the location.

In a further aspect, the apparatus of the hereinafter or the hereinbefore may further provide that the periodic signal updates include the position and time stamp data from the orbiting GPS satellites; and/or the host server further includes a processing unit configured to analyze the position and time stamp data to determine a location of the apparatus.

In a further aspect, the apparatus of the hereinafter or the hereinbefore may further provide that the periodic signal updates further include an identifier number of the apparatus which has been pre-registered with the fulfilment center as being associated with at least one of a customer name, a customer address and a customer vehicle identifier; and/or when the signal anomaly detection unit identifies any of the interruptions attributable to the interrupting device and/or occurring for the predetermined duration and/or in the predetermined pattern over the predetermined pattern duration, the host server is configured to output a control signal which includes a command to deliver the product and/or service to at least one of the customer address or a customer vehicle located at the location of the apparatus, the customer vehicle being identifiable by way of the customer vehicle identifier, and/or a command to bill the user for the product and/or service in accordance with billing instructions that have been pre-registered with the fulfillment centre.

In a further aspect, the apparatus of the hereinafter or the hereinbefore may further provide that the periodic signal updates are transmitted at equal intervals lasting anywhere between 0.1 seconds and 5 hours; and/or the interrupting device interrupts the periodic signal updates for the predetermined duration, the predetermined duration lasting anywhere between 0.2 seconds and 24 hours.

In a further aspect, the apparatus of the hereinafter or the hereinbefore may further provide that the periodic signal updates are transmitted at equal intervals lasting anywhere between 0.1 seconds and 5 hours; and/or the interrupting device interrupts the periodic signal updates in the predetermined pattern over the predetermined pattern duration, the predetermined pattern consisting of skipping a pre-selected number of the periodic signal updates over the predetermined pattern duration lasting anywhere between 0.2 seconds and 24 hours.

In a further aspect, the apparatus of the hereinafter or the hereinbefore may further provide that the control mechanism is a push button.

In a further aspect, the apparatus of the hereinafter or the hereinbefore may further provide that the periodic signal updates are transmitted by the signal receiver-emitter by way of wi-fi, Bluetooth, radio, cellular network or satellite modem connection.

In a further aspect, the apparatus of the hereinafter or the hereinbefore may further provide that when the control mechanism is activated by the user, the interrupting device is configured to repeat the interruption of the periodic signal updates a preselected number of times and/or over a preselected period of time; and/or the signal anomaly detection unit of the host receiver is further configured to ignore any duplicate interruptions in the periodic signal anomalies, having the predetermined duration and/or the predetermined pattern and pattern duration, which occur in a predetermined window of time, so as to prevent any unwanted duplication in customer orders.

In a further aspect, the apparatus of the hereinafter or the hereinbefore may further provide that the interrupting device is associated with at least one control mechanism, and the interrupting device is selectively operable via each of the at least one control mechanisms to effect a distinct interruption in the periodic signal updates; and/or data representing each distinct interruption in the periodic signal updates is pre-registered with the fulfilment centre as identifying a distinct product and/or service for order.

Furthermore, the described features and advantages of the disclosure may be combined in various manners and embodiments as one skilled in the relevant art will recognize. The disclosure can be practised with or without one or more features and advantages in a particular embodiment.

Further advantages of the present disclosure will become apparent from a consideration of the drawings and ensuing description.

### BRIEF DESCRIPTION OF THE DRAWINGS

The advantages and features of the present disclosure will become understood with reference to the following more detailed description and claims taken in conjunction with the accompanying drawings, and in which:

FIG. 1 provides a schematic diagram illustrating the operation of a system for ordering a product and/or service in accordance with a preferred embodiment of the invention;

FIG. 2 provides a frontal and perspective view of one possible embodiment of an ordering apparatus which may form part of the system as shown in FIG. 1;

FIG. 3 provides a schematic block diagram illustrating the various components of the apparatus shown in FIG. 2;

FIG. 4A provides a line graph of a transient predetermined order signal in accordance with a preferred embodiment of the invention;

FIG. 4B provides a line graph of the transient predetermined order signal depicted in FIG. 4A, which has been interrupted for a predetermined duration by an interrupting device of the apparatus shown in FIG. 2;

FIG. 4C provides a line graph of the transient predetermined order signal depicted in FIG. 4A, which has been interrupted in a predetermined pattern for a predetermined pattern duration by an interrupting device of the apparatus shown in FIG. 2;

FIG. 5A provides a line graph of a constant predetermined order signal in accordance with an alternate embodiment of the invention;

FIG. 5B provides a line graph of the constant predetermined order signal depicted in FIG. 5A, which has been interrupted for a predetermined duration by an interrupting device of the apparatus shown in FIG. 2;

FIG. 5C provides a line graph of the constant predetermined order signal depicted in FIG. 5A which has been interrupted in a predetermined pattern for a predetermined pattern duration by an interrupting device of the apparatus shown in FIG. 2; and

FIG. 6 provides a schematic block diagram illustrating the various components of one possible embodiment of a host receiver as depicted in the system of FIG. 1.

### DETAILED DESCRIPTION OF THE PREFERRED EMBODIMENT

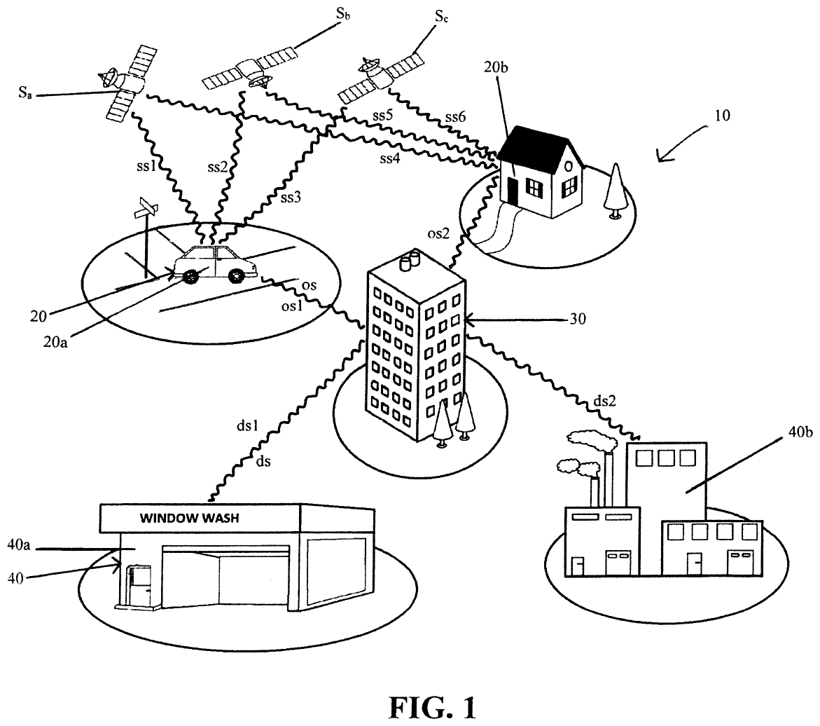

Reference may now be had to FIG. 1, which depicts a preferred embodiment of a system 10 for ordering a product and/or service. As may be seen from FIG. 1, the system 10 includes a plurality of ordering apparatuses or signal receiver-emitters 20. By way of non-limiting example, FIG. 1 depicts two such apparatuses 20a, 20b. The ordering apparatus 20a is depicted as being contained within a user vehicle and, as will be described later, is operable to allow remote ordering of window washing services. The ordering apparatus 20b is depicted as being contained within a user's home residence and, for example, is operable to allow a homeowner to order various household products, such as laundry detergent or toilet paper, for example. The system 10 further includes a host receiver 30 that is illustrated in FIG. 1 as being contained within an office building. The system 10 further includes one or more fulfillment centres 40, such as the window washing facility 40a and the factory 40b of FIG. 1.

As may be seen in FIG. 1, each of the ordering apparatuses 20a, 20b are configured to receive satellite signals ss1, ss2 . . . ss6 from orbiting GPS satellites Sₐ, S_{b}, S_{c}. The satellites Sₐ, S_{b}, S_{c} form part of a larger Global Navigation Satellite System (GNSS) such as, for example, the United States' Global Positioning System (GPS), Russia's Global Navigation Satellite System (GLONASS) or the European Union's Galileo, amongst others. Each of the satellite signals ss1, ss2 . . . ss6 include accurate position and time stamp data of the satellites Sₐ, S_{b}, S_{c}, and are configured such that any GPS receiver within range may intercept the signals ss1, ss2 . . . ss6 in order to decode their respective position and time stamp data and determine a location of the GPS receiver. This calculation is accomplished using a process termed ‘trilateration’, which requires position and time stamp data from three or more satellites in order to engage in a geometric exercise of determining position based on calculated distances from each of the relevant satellites Sₐ, S_{b}, S_{c}.

As will be described with reference to FIG. 3, each of the ordering apparatuses 20 forming part of the system 10 include a GPS receiver 26 that is configured to receive the satellite signals ss1, ss2 . . . ss6 either directly or indirectly from the satellites Sₐ, S_{b}, S_{c}. With the position and time stamp data of the satellite signals ss1, ss2 . . . ss6, an ordering apparatus 20 of the system 10 is able to accurately determine its location in the form of GPS coordinates. As will be described later, the GPS coordinates may then be transmitted by the ordering apparatus 20 to the host receiver 30 by way of an associated predetermined order signal os, such as the order signals os1 and os2 depicted in FIG. 1.

The applicant has envisioned a number of different modes for transmitting the order signals os, os1, os2 to the host receiver 30, depending upon the particular application. In FIG. 1, the order signals os1, os2 are transmitted over a mobile communications network, using such standards as Global System for Mobile Communication (GSM) and/or General Packet Radio Services (GPRS). However, depending upon cost, size and distance restrictions, the order signals os, os1, os2 may, in alternative embodiments, be transmitted by way of radio waves, satellite modem connection, Wi-Fi, or even Bluetooth.

As will be described with reference to FIG. 3 below, the order signals os, os1, os2 transmitted to the host receiver 30 include one or more preselected signal anomalies, which consist of at least one preselected interruption that (based upon pattern and/or duration) serves to indicate the product and/or service being requested by the user.

Having received a request for a particular product and/or service from an ordering apparatus 20, the host receiver 30 is configured to issue an appropriate control or dispatch signal/command ds to an appropriate fulfillment centre 40. In FIG. 1, the host receiver 30 is depicted as issuing the dispatch signal ds1 to the window washing facility 40a upon receiving the order signal os1 from the apparatus 20a located within the user's vehicle. Similarly, the host receiver 30 is illustrated as sending the dispatch signal ds2 to the factory 40b upon receipt of the order signal os2 from the apparatus 20b located at the user's home residence.

Much like the order signals os, os1, os2, the dispatch signals ds, ds1, ds2 may take the form of a signal transmitted over at least one of a mobile communications network, radio, satellite modem connection, Wi-Fi or Bluetooth. In the preferred embodiment depicted in FIG. 1, however, the dispatch signals ds1, ds2 are issued by the host receiver 30 in the form of instructions sent by e-mail to the relevant fulfillment centres 40a, 40b. Upon receiving the order signals os1, os2, the host receiver 30 thus accesses the internet over a wired or wireless connection in the office building in which it is located, in order to send the relevant e-mails issuing the dispatch signals ds1, ds2. In an alternative embodiment, the dispatch signals or commands ds1, ds2 may be issued verbally by a telephone operator working in the office building in which the host receiver 30 is located. The invention is not so limited, however. The applicant has recognized that a number of different alternatives may be used to communicate the dispatch signals or commands ds, ds1, ds2 to each of the relevant fulfillment centres 40, 40a, 40b.

### The Ordering Apparatus

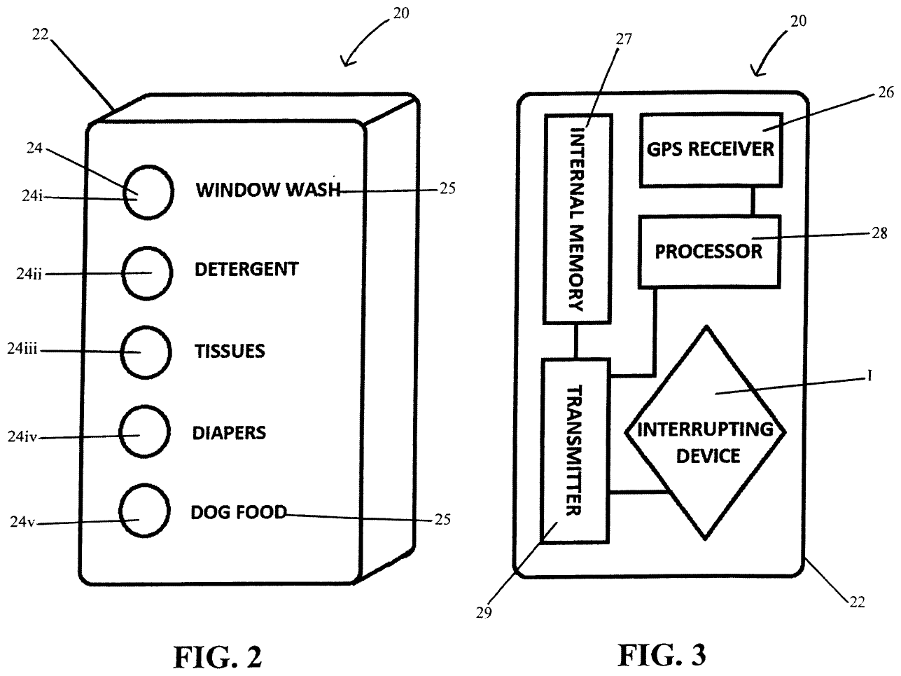

FIGS. 2 and 3, together, provide an outer and inner illustration of one possible embodiment of an ordering apparatus 20, which may be used in the system 10. As may be seen from FIG. 2, the ordering apparatus 20 includes an outer casing 22 that features a plurality of control mechanisms 24 in the form of push buttons that may be pressed by a user when he/she wishes to place an order for a particular product and/or service. Each of the individual control mechanisms 24i, 24ii . . . and 24v depicted in FIG. 2 may optionally be labeled with printed indicia 25 denoting the appropriate control mechanism 24 which has been pre-associated or pre-assigned to a particular product and/or service. The apparatus in FIG. 2, for example, features exactly five separate push button control mechanisms 24i, 24ii . . . and 24v, each of which having been labeled to correspond to various products and/or services including window washing services, detergent, tissues, diapers and dog food, respectively. Hence, a user wishing to place an order for window washing services would make use of the first control mechanism 24i to send an order signal os, such as the order signal os1 of FIG. 1, to request window washing services.

FIG. 3 provides a schematic block diagram which illustrates the various components included in a preferred embodiment of the ordering apparatus 20, also depicted in FIG. 2. As may be seen in FIG. 3, the ordering apparatus 20 includes a GPS receiver 26, a processor 28, a transmitter 29 and an interrupting device I, all of which being housed in the casing 22.

In addition to the foregoing, the ordering apparatus 20 also includes within the casing 22, an internal memory 27 which stores a unique identifier number of the ordering apparatus 20. Each ordering apparatus 20, 20a, 20b of the system 10 has an internal memory 27 that stores a different unique identifier number, which serves to differentiate the different apparatuses 20, 20a, 20b from one another. For example, ordering apparatus 20a depicted in FIG. 1 may have stored in its internal memory 27 the unique identifier number 0XI45T3, while the ordering apparatus 20b may have stored in its internal memory 27 the unique identifier number 0XZ76Q2. The applicant has envisioned that any length string of alphanumeric numbers, letters and/or symbols may be used in the creation of different unique identifier numbers for each of the ordering apparatuses 20, 20a, 20b.

As was described above, the GPS receiver 26 is the component of the ordering apparatus 20 responsible for receiving the satellite signals ss1, ss2 . . . ss6 from the orbiting GPS satellites Sₐ, S_{b}, S_{c}. The processor 28 of the ordering apparatus 20 communicates with the GPS receiver 26 in order to decode the satellite signals ss1, ss2 . . . ss6 to obtain the position and time stamp data of satellites Sₐ, S_{b}, S_{c} and determine the location of the ordering apparatus 20 in the form of GPS coordinates.

Once calculated, the GPS coordinates of the ordering apparatus 20 may be transmitted as part of the order signals os, os1, os2 to the host receiver 30. In this preferred embodiment, the transmitter 29 regularly transmits the order signals os to the host receiver 30 at predetermined equal intervals of time throughout the day and/or night. In particular, the order signals os1, os2 are transmitted every 15 minutes between the hours of 9:00 AM and 10:00 PM.

The applicant has recognized that different predetermined equal intervals of time may be used in the transmission of the order signals os, os1, os2, depending upon the nature of the product(s) and/or service(s) associated with the relevant ordering apparatus 20. For instance, in an alternate embodiment, an ordering apparatus 20 may be configured to request emergency services, such as an ambulance, fire truck or police. In such an embodiment, the transmitter 29 of the ordering apparatus 20 may be configured to transmit order signals os at much tighter intervals in the range of, for example, anywhere between about 0.1 and 60 seconds. In an ordinary retail setting, a transmitter 29 of an ordering apparatus 20 may be configured to transmit order signals os to a host receiver 30 at predetermined equal intervals of time that last anywhere between about 1 minute and 24 hours, depending upon how urgently an order is to be placed, and upon other requirements such as power or bandwidth limitations of the particular ordering apparatus.

In addition to the GPS coordinates calculated by the processor 28, the order signals os, os1, os2 transmitted by the transmitter 29 of the ordering apparatuses 20, 20a, 20b also include a copy of the unique identifier number which has been stored in the internal memory 27 of their associated ordering apparatus 20, 20a, 20b. In this way, each of the order signals os, os1, os2 is given a unique signature, which may be read by the host receiver 30 as identifying that particular order signal os, os1, os2 as originating from or belonging to the relevant ordering apparatus 20, 20a, 20b.

The interrupting device I is electronically and/or physically coupled to the various control mechanisms 24i, 24ii . . . 24v of the ordering apparatus 20, and once activated by way of these control mechanisms 24i, 24ii . . . 24v, is configured to effect at least one preselected signal anomaly in the order signal os, os1, os2 being transmitted by the transmitter 29. The aforementioned signal anomaly consists of interrupting the order signal os, os1, os2 for a predetermined duration or in a predetermined pattern for a predetermined pattern duration. Furthermore, the interrupting device I is configured such that each of the different control mechanisms 24i, 24ii . . . 24v triggers a different interruption having a distinct predetermined duration or predetermined pattern and pattern duration, different from the rest. Thus, depending upon which control mechanism 24i, 24ii . . . 24v is triggered, a different interruption having a different predetermined duration or predetermined pattern and pattern duration is applied to the order signal os, os1, os2. The different predetermined durations or predetermined patterns and pattern durations to be effected by the interrupting device I, and which are associated with each of the various control mechanisms 24i, 24ii . . . 24v, may be pre-programmed into the interrupting device I.

The pre-programmed predetermined duration or predetermined pattern and pattern duration associated with any particular control mechanism 24i, 24ii . . . 24v may vary according to the particular application. For example, where the transmitter 29 of the ordering apparatus 20 transmits the order signal os at predetermined equal intervals of 10 minutes, the interrupting device I may be pre-programmed to interrupt the order signal os for a predetermined duration of 1 hour, following the activation of the control mechanism 24v, thus signalling to the host receiver 30 an order for dog food. Alternatively, the interruption in the order signal os may consist of a predetermined pattern that effectively extends those 10 minutes so that the order signal os is, rather, sent every 30 minutes, for a predetermined pattern duration of 3 hours.

In an alternate embodiment, where the ordering apparatus 20 is used for requesting emergency services, the interrupting device I may be pre-programmed to interrupt the order signal os, which regularly occurs every 0.5 seconds, for a predetermined duration of 5 seconds, thus signaling to the host receiver 30 that an ambulance is being requested. Similarly, the interrupting device I may be pre-programmed to interrupt the order signal os in a predetermined pattern, which consists of skipping every third transmission of the order signal os (effectively extending the predetermined equal intervals of time from 0.5 seconds to 1.0 seconds) for a predetermined pattern duration of 1 minute.

In the present embodiment, the interrupting device I of the ordering apparatus 20a has been pre-programmed to interrupt the order signal os1, which regularly occurs at predetermined equal intervals of 15 minutes, for a predetermined duration of 2 hours, the predetermined pattern duration of 2 hours having been pre-registered with the host receiver 30 as signaling an order for window washing services (see FIG. 1). Similarly, the interrupting device I of the ordering apparatus 20b has been pre-programmed to interrupt the order signal os2 (also regularly occurring at predetermined intervals of 15 minutes), such as to skip every fourth occurrence of the order signal os2 (effectively extending the predetermined intervals of time from 15 to 45 minutes) over a predetermined pattern duration of 4 hours. Thus, effectively, over the predetermined pattern duration of 4 hours, the transmitter 29 (being actively blocked by the interrupting device I in the aforementioned predetermined pattern) would only transmit the order signal os2 to the host receiver 30 at the following points in time following activation via the relevant control mechanism 24: zero minutes, 45 minutes, 1 hour and 30 minutes, 2 hours and 15 minutes, 3 hours, 3 hours and 45 minutes. To be contrasted with the status quo, wherein the transmitter 29 of the apparatus 20b (without any active interruptions) transmits the signal os2 every 15 minutes.

Given that in the preferred embodiment the transmitter 29 of the relevant ordering apparatuses 20a, 20b has been pre-programmed to transmit the order signals os1, os2 every 15 minutes, when activated by the relevant control mechanism 24, the interrupting device I of the ordering apparatuses 20a, 20b interrupts or blocks the transmission of the order signals os1, os2 in the manner described above. The applicant has envisioned various means by which to accomplish the interruptions. For example, the interrupting device I may configured to block power supplied to the transmitter 29, so as to effectively shut down the transmitter 29 over the predetermined duration or so as to effect the interruption in the predetermined pattern over the course of the predetermined pattern duration. Alternatively, the interrupting device I may function as a signal blocker, and rather than power off or prevent the transmitter 29 from sending signals, may merely intercept and stop the signals from ever leaving the casing 22 of the relevant ordering apparatus 20, 20a, 20b.

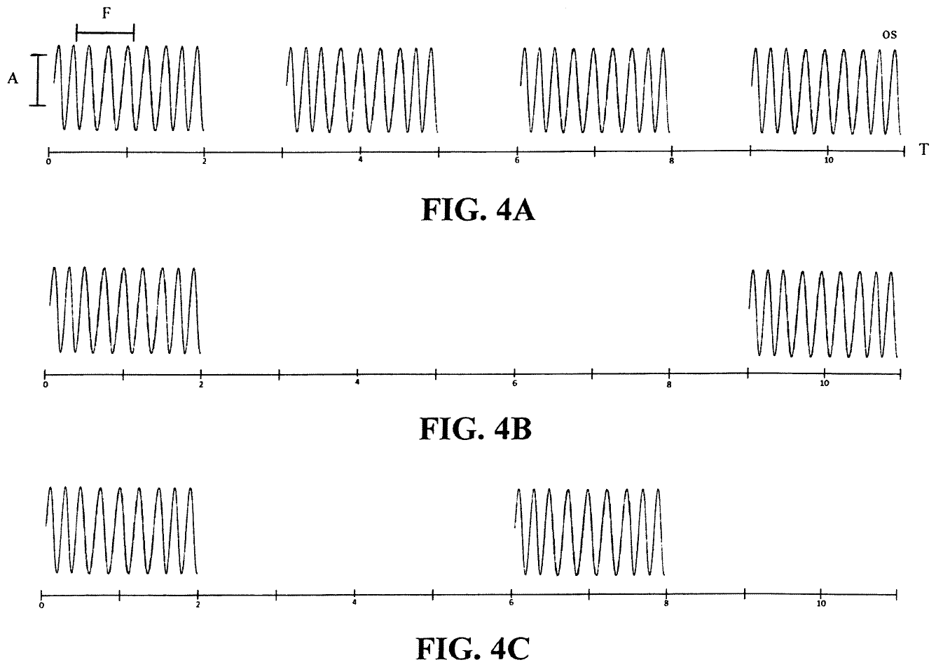

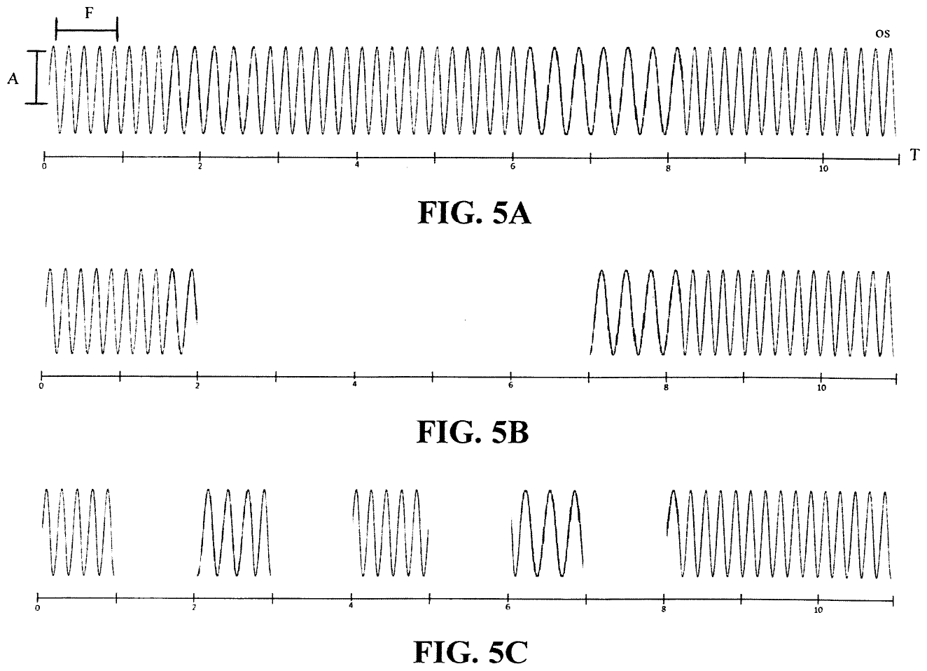

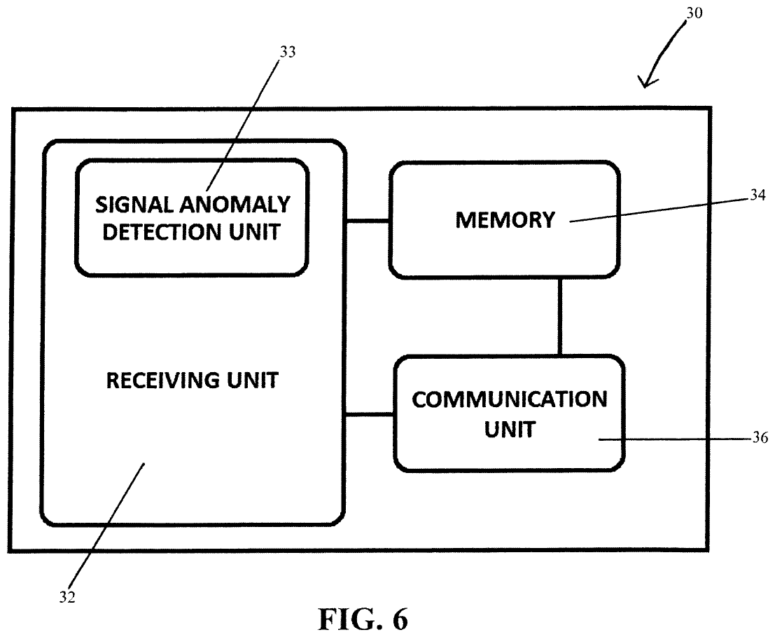

FIGS. 4A to 4C and FIGS. 5A to 5C provide line graphs of two separate embodiments of order signals os according to the present invention. FIGS. 4A to 4C depict a transient order signal os in line with the various embodiments described above, in that the illustrated order signal os is transmitted at predetermined equal intervals of time. As may be seen from FIG. 4A, the order signal os is transmitted about every 3 minutes in bursts of about 2 minutes, the x-axis of each of FIGS. 4A to 4C and 5A to 5C denoting time T in minutes.

The order signal os depicted in FIG. 4A is further depicted as having an amplitude A and a frequency F. In this particular embodiment, the amplitude A of the order signal os remains substantially unchanged, whereas the frequency F varies very slightly, thus conveying data or information. The applicant has recognized that information and/or data may be conveyed by way of electromagnetic signals either by varying the amplitude A of a signal (such as, for example, in AM radio transmissions) or by varying frequency (such as, for example, in FM radio transmissions), or both. Seeing as mobile networks generally operate to transmit information by way of frequency modulation, the order signals os1, os2 of the preferred embodiment of the invention also incorporate frequency modulations, whilst maintaining a substantially constant amplitude. Alternate embodiments of the invention, however, may make use of amplitude modulation (or a combination of amplitude and frequency modulation) in order to convey data in the order signals os transmitted by the ordering apparatuses 20.

The line graph of FIG. 4A specifically depicts the order signal os in its natural state, as it is sent by the transmitter 29 of the ordering apparatus 20. FIG. 4B represents the same order signal os having been interrupted by the interrupting device I of the ordering apparatus 20. Specifically, FIG. 4B represents the order signal os presenting with a preselected signal anomaly that consists of an interruption starting at about 2 minutes and having the predetermined duration lasting somewhere between about 6 to 7 minutes.

FIG. 4C, like FIG. 4B, depicts the order signal os of FIG. 4A, but exhibiting a preselected signal anomaly having an interruption with a predetermined pattern that consists of skipping every second burst of the order signal os (effectively lengthening the predetermined equal intervals of time between said bursts from about 3 to 6 minutes). FIG. 4C illustrates the interruption having the aforementioned predetermined pattern occurring over the course of about 11 minutes. However, the interruption may continue for a longer predetermined pattern duration than that depicted in the line graph.

FIGS. 5A to 5C are similar to FIGS. 4A to 4C, but rather, depict an order signal os which is substantially constant, that is, which does not exhibit any significant interruptions in the normal course (i.e. without interference of the interrupting device I), as may be seen from FIG. 5A. Similarly to FIGS. 4A to 4C, the order signal os of FIGS. 5A to 5C is provided with a substantially constant amplitude A and with a varying frequency F.

FIG. 5B illustrates the order signal os of FIG. 5A, only having been interrupted by the interrupting device I in a similar manner as that depicted in FIG. 4B. As may be seen, the order signal os is illustrated in FIG. 5B presents with a signal anomaly according to the present invention that consists of an interruption beginning at about 2 minutes and lasting for a predetermined duration of about 5 minutes.

Similarly, FIG. 5C depicts the order signal os of FIG. 5A, presenting with a signal anomaly that consists of interrupting the order signal os in a predetermined pattern resembling a pulsed pattern, wherein the interruption is repeated about every 2 minutes in bursts lasting about 1 minute. The pulse pattern interruption is further depicted as beginning at a time of about 1 minute, and lasting over a predetermined pattern duration of about 7 minutes.

As the transmittance of order signals os according to the present invention generally require a power source, it is preferable that a transient signal such as the order signal os depicted in FIGS. 4A to 4B be used where energy reserves are to be conserved. By way of example, the ordering apparatus 20a of FIG. 1 is envisioned as being a mobile apparatus that operates using battery power. In order to conserve power levels in the battery, the transmitter 29 of the ordering apparatus 20a may limit the number of transmissions per hour by maintaining a transient order signal os1 having longer predetermined equal intervals of time. Alternatively, where shorter predetermined equal intervals of time are desired for the order signal os1 (in order to help expedite customer orders), the transmitter may be pre-programmed to halt any transmission of the order signals os1 until such time as a customer order is desired, and the interrupting device I is activated.

A constant order signal os, such as the one depicted in FIGS. 5A to 5B, inherently requires a greater amount of energy to produce, as compared to a transient signal which contains a number of breaks or pauses throughout. While a constant order signal os may be employed in a mobile apparatus 20 for use in the system 10, it is preferable that such an order signal os be used in a setting where power reserves are plentiful. Take for example, the order signal os2 of FIG. 1, which originates from the ordering apparatus 20b located in the user's home residence. While the ordering apparatus 20b may still be provided as a battery operated mobile apparatus; being provided in a user's home, it may be more suitable for emitting a constant order signal, if the ordering apparatus 20b is hooked up to a charger or other continuous power supply. Alternatively, the order signal os2 may be transmitted on-demand within the user's home residence over a wired or wireless (e.g. Wi-Fi or Bluetooth) connection in a signal burst which already incorporates therein the pre-selected signal anomaly.

### The Host Receiver

FIG. 4 depicts a schematic block diagram of one possible embodiment of a host receiver 30 that may be incorporated into the system 10 of FIG. 1. As may be seen from FIG. 4, the host receiver 30 includes each of a receiving unit 32, a physical memory 34 and a communication unit 36. The receiving unit 32 furthermore incorporates a signal anomaly detection unit 33.

The receiving unit 32 of the host receiver 30 is configured to monitor incoming signals, including the order signals os, os1, os2 that are transmitted by the ordering apparatuses 20, 20a, 20b.

The physical memory 34 of the host receiver 30 stores various forms of data, which include reference data used for identifying the unique signatures of each order signal os, os1, os2. As such, the memory 34 of the host receiver 30 stores data which may be used to identify each unique identifier number that has been pre-associated with each particular ordering apparatus 20, 20a, 20b of the system 10.

In addition to the foregoing, the physical memory 34 also stores a host of customer information data, which can include such information as customer names, customer addresses, customer e-mail addresses, customer phone numbers, as well information for use in identifying customer vehicles (e.g. customer license plate numbers, make or model numbers of customer vehicles, etc.). Each cluster of customer information data stored in the memory 34 is further correlated so as to be directly linked or associated with a particular unique identifier number of the various apparatuses 20, 20a, 20b operating in the system 10. In this way, incoming order signals os, os1, os2 that include a copy of their relevant apparatus' unique identifier number may be immediately identified by the host receiver 30 as originating from a particular customer. For example, the memory 34 of the host receiver, may have stored therein data for identifying the unique identifier number 0XI45T3 of the ordering apparatus 20a, that has been linked to stored customer information data which includes a license plate and make and model number of the user's vehicle shown in FIG. 1, along with the user's name and mailing address. This information may also be accessed by the communication unit 36 of the host receiver 30 when preparing to transmit the dispatch signal/command ds1. For example, if the customer has provided that orders are to be delivered directly to his/her vehicle (at its current GPS coordinates), the communication unit 36 may provide in its dispatch command ds1 to the fulfilment centre 40a details of the customer's vehicle. Similarly, where a customer has previously indicated that orders are to be directly delivered to his/her home residence, the communication unit 36 may provide in its dispatch command ds to the relevant fulfilment centre 40 details of the customer's pre-stored address.

The aforementioned reference and customer information data may be stored in the physical memory 34 in the form of a suitable matrix, chart, or other suitable data structure as may be known in the art.

The receiving unit 32 of the host receiver 30 is thus configured to communicate directly with the physical memory 34, so as to compare the data received from order signals os, os1, os2 to the reference and customer information data stored in the memory 34.

In some embodiments, the physical memory 34 of the host receiver may also store data and/or information that may be used by the host receiver 30 to identify a transient order signal os based on its pulse pattern and rate, that is, based on the length of its individual bursts and on its predefined or predetermined equal intervals of time (i.e. in the absence of any interruptions by a interrupting device I). In such embodiments, a unique identifier number may not necessarily be required, as the order signals os may be identified as belonging to a particular ordering apparatus 20 based solely on the transient properties of its associated order signal os. The order signal os of such an ordering apparatus may, thus, in and of itself function as a unique signature. The ordering apparatus 20, not requiring a unique identifier number, may thus be built without an internal memory 27, which could substantially reduce manufacturing costs.

In addition to the foregoing, the physical memory 34 of the host receiver 30 also stores data that may be used by the receiving unit 32 to identify the preselected signal anomalies occurring in the order signals os, os1, os2, and which are specifically attributable to their respective interrupting devices I. In particular, the memory 34 stores data that may be used by the signal anomaly detection unit 33 of the receiving unit 32 to identify the predetermined duration or predetermined pattern and pattern duration of specific preselected interruptions corresponding to those preselected signal anomalies.

Data representing each of the predetermined durations and predetermined patterns and pattern durations of the different preselected signal anomalies are further linked in the physical memory 34 to pre-stored order information data. The order information data may, for example, include such information as: which fulfillment centre 40, 40a, 40b to contact to supply the requested product/service, the quantity of product to be included in the order (if relevant), a delivery address for the product and/or service (if different from the customer address stored as part of the customer information data), instructions on how to bill the customer for products/services ordered (i.e. pre-registered payment details, etc.), and/or other miscellaneous information regarding the manner in which to fill the customer's order.

Like the reference and customer information data, the aforementioned order information data and the data representing the predetermined durations/predetermined patterns and pattern durations may be stored in the physical memory 34 in the form of a matrix, chart, or other suitable data structure.

In preferred embodiments of the invention, a specific user or customer would pre-register all of the aforementioned reference, customer information and order information data with the host receiver 30 prior to placing an order using any of the ordering apparatuses 20, 20a, 20b. In this way, the system 10 may provide a customizable user experience.

Upon detecting a preselected signal anomaly in one or more of the order signals os, os1, os2, the receiving unit 32 of the host receiver 30 is configured to instruct the communication unit 36 of the host receiver 30 to initiate the relevant dispatch signal ds, ds1, ds2 to the appropriate fulfillment centre 40, 40a, 40b. In placing the dispatch signal ds, ds1, ds2, the communication unit 36 communicates with the memory 34 in order refer to the aforementioned order information data, which as described above, has been previously correlated to the predetermined duration or predetermined pattern and pattern duration of the preselected signal anomaly.

In a further embodiment of the invention, the host receiver 30 may choose the fulfillment centre 40, 40a, 40b to which it sends a particular dispatch signal or command ds, ds1, d2 based on a variety of factors that may include, for example, proximity of the chosen fulfillment centre 40 to the current GPS coordinates of the relevant ordering apparatus 20, or current availability of the requested product or worker(s) to perform a requested service at the chosen fulfillment centre 40.

In some embodiments of the invention, the interrupting device I of a particular ordering apparatus 20 may have been pre-programmed to, upon activation, repeat the preselected signal anomaly in the order signal os a preselected number of times over a preselected period of time. For example, a particular interrupting device I may have been pre-programmed to effect a particular signal anomaly in an order signal os a total of 10 times, over a period of 2 days. In particular, the interrupting device may have been pre-programmed to repeat the preselected signal anomaly every 4.5 hours for 2 days, so as to minimize the effects of any potential problems that may occur when transmitting the original order signal os with associated preselected signal anomaly.

In the above-noted embodiment, a host receiver 30 may be configured to ignore any duplicate detections of the same preselected signal anomaly in a particular order signal os originating from a particular ordering apparatus 20. In order to facilitate the task, the host receiver may be preprogrammed with a predetermined window of time in which to monitor incoming order signals os for duplicate preselected signal anomalies. For example, the signal anomaly detection unit 33 of a host receiver 30 may be pre-programmed to ignore any of the same preselected signal anomalies occurring in a particular order signal os in a predetermined window of 10 days. The predetermined window of time may be preselected based on a variety of factors including, for example, the particular product and/or service associated with the relevant preselected signal anomaly. A predetermined window of 10 days may be chosen, for example, because a customer is unlikely to place the same order for, for example, laundry detergent, multiples times in 10 days.

Upon detecting a first occurrence of a particular signal anomaly in an order signal os, the host receiver 30 may be further configured to assign open a new order “ticket”, corresponding to a new customer order and indicating all of the relevant information for that order through reference to the data stored in the physical memory 34 of the host receiver 30. In some embodiments, the open “ticket” may also be assigned an order number, which reflects the number of orders a particular customer has placed in total. That is, where a customer has placed four separate orders through his/her ordering apparatus 20, the order number assigned by the host receiver 30 to a new order received by way of preselected signal anomaly in the order signal os would be “0004”.

Upon receiving the order signal with the aforementioned preselected signal anomaly, the communication unit 36 of the host receiver 30 may be configured to forward to the appropriate customer an order confirmation receipt. Such an order confirmation may, for example, be forwarded by way of e-mail to the selected customer's pre-stored e-mail address, and may include such information as the quantity and/or nature of the product and/or service ordered, billing information, and the above-noted order number.

Following (or concurrently with) the issuance of the above-noted order confirmation receipt, the communication unit 36 transmits the dispatch signal/command ds to the appropriate fulfillment centre 40, as is described above. Once the dispatch signal/command ds has been sent, the fulfillment centre may transmit its own confirmation receipt back to the host receiver 30, thus positively indicating that the order has been received and that fulfillment of the order is in progress. This second confirmation receipt may also contain further information, as for example, shipping or further billing information, estimated delivery/arrival time(s) of the requested products and/or services, etc. Upon receive the confirmation receipt from the fulfillment centre 40, the host receiver 30 may mark its previously opened “ticket” as having been “completed” or “in progress”, as appropriate. Subsequent status updates from the relevant fulfillment centre 40 may also lead to further updates to the relevant “ticket”. Further updates, including shipping notices, etc., may also be sent to the customer by the communication unit 36 if and when the host receiver 30 updates the aforementioned “ticket”.

It should be appreciated that each of the apparatuses 20 and the host receiver 30 may be provided in a variety of locations. Although the preferred embodiment of the invention describes the apparatuses 20a and 20b as being respectively located within a user's vehicle and a user's home residence, the applicant has recognized that any apparatuses 20 forming part of the system 10 may also alternatively be provided, for example, at a user's workplace, on a user's motorcycle, boat or recreational vehicle, at a user's vacation property, etc. The applicant has envisioned that such apparatuses 20 may be provided as mobile units capable of being transported to any particular location, or of being kept on a user's person at all times.

Similarly, the applicant has recognized that the host receiver 30 of the system 10 is not limited to the preferred embodiment as illustrated in FIG. 1, and may alternatively be provided in various locations depending upon the particular application. By way of example, the host receiver 30, in an alternate embodiment, may be provided within one of the fulfillment centres 40 of the system 10, such as the window washing facility 40a or the factory 40b depicted in FIG. 1.

Although FIG. 1 depicts only two types of fulfillment centres, a window washing facility 40a and a factory 40b, the invention is not so limited. It should be appreciated that the type of fulfillment centre contacted by the host receiver 30, in order to respond to a user's request for a product and/or service, is dependent upon the type of product and/or service requested. While FIG. 1 depicts a window washing facility 40a for responding to a user's request for car window washing services, the applicant recognizes that alternative types of fulfillment centres may also fall within the scope of the invention. For example, if a user were to place an order requesting a refill of paper towels and canned food, the host receiver 30 may submit a dispatch request or command to a warehouse known to stock both of these items, in order to properly respond to the customer's order in a timely fashion and with fewer shipments. Similarly, were a user to submit an order for electrical maintenance of a kitchen appliance, the host receiver 30 may transmit a dispatch signal to a maintenance facility known to employ suitable electricians for responding to the customer's request for service.

While the ordering apparatus 20 depicted in FIG. 2 features exactly five control mechanisms 24i, 24ii, 24iii, 24iv and 24v, it is to be appreciated that apparatuses 20 of the system 10 may include a different number of control mechanisms 24, other than that depicted in FIG. 2. The ordering apparatus 20 in an alternate embodiment may, for example, feature a single control mechanism 24 associated with the ordering of a single type (or combination) of product and/or service. Similarly, an alternate ordering apparatus 20 may also include more than five control mechanisms, each one being associated with a different product and/or service, different from those depicted in FIG. 2. The applicant has envisioned a number of different arrangements and quantity of control mechanisms 24 that may be included in any particular ordering apparatus 20, depending upon the application. Further, the applicant has recognized that a single control mechanism 24 may also be associated with the ordering of more than one product and/or service at a time. For example, a user may wish a particular control mechanism 24 to be pre-set to initiate the order of their weekly grocery list.

Although FIG. 2 depicts the ordering apparatus 20 as including control mechanisms 24 in the form of push buttons, the invention is not so limited. It should be appreciated that a variety of different types of control mechanisms 24 may be used to activate the interrupting device I of the ordering apparatus 20. For example, in place of a push button, the control mechanism 24 may include a latch or switch. The applicant envisions there are a number of different alternatives that may be used for triggering the interrupting device I in a particular ordering apparatus 20.

While the present disclosure provides a number specific examples of preselected signal anomalies having predetermined durations or predetermined patterns and pattern durations, the invention is not limited to those examples. It should be appreciated that the predetermined durations and predetermined patterns and pattern durations of any particular signal anomaly applied to an order signal os may be varied according to the application. The applicant has envisioned that the interrupting device I of a particular ordering apparatus 20 may be preprogrammed to effect the signal anomaly having an interruption occurring for any particular predetermined duration and/or occurring in a variety of different predetermined patterns over a customizable predetermined pattern duration.

Although the preferred embodiment of the invention describes each of the ordering apparatuses 20, 20a, 20b as including a processor 28 that is configured to decode the satellite signals ss1, ss2 . . . ss6 to obtain the position and time stamp data of satellites Sₐ, S_{b}, S_{c} and to determine the location of the ordering apparatus 20, 20a, 20b, the invention is not thus limited. Alternatively, the applicant has recognized that the host receiver 30 may itself contain a processing unit configured to analyze the position and time stamp data of the satellite signals ss1, ss2 . . . ss6, in order to determine location information of each of the individual ordering apparatuses 20, 20a, 20b. In such an embodiment, raw satellite data including the position and time stamp data of the orbiting GPS satellites Sₐ, S_{b}, S_{c} may be transmitted with the order signals os, os1, os2 instead of calculated GPS coordinates. Once received by the receiving unit 32 of the host receiver 30, the position and time stamp data included in the order signals os, os1, os2 may be analyzed by the aforementioned processing unit to determine GPS coordinates of each individual ordering apparatus 20, 20a, 20b. In such an embodiment, the ordering apparatuses 20, 20a, 20b may be built without individual processors 28, thereby substantially reducing their manufacturing costs, and potentially reducing sizing requirements of individual casings 22 of the ordering apparatus 20, 20a, 20b.

It should furthermore be appreciated that each of the ordering apparatuses 20 and host receiver 30 may be varied according to the application, and to the user's own preferences.

The foregoing descriptions of specific embodiments have been presented for the purposes of illustration and description. They are not intended to be exhaustive or to limit the invention and method of use to the precise forms disclosed. The various modifications and variations can be appreciated by one skilled in the art in light of the above teachings. The embodiments have been chosen and described in order to best explain the principles and practical application in accordance with the invention in order to enable those skilled in the art to best utilize the various embodiments with expected modifications as are suited to the particular use contemplated. It is understood that various omissions or substitutions of equivalence are contemplated as circumstance may suggest or render expedient, but is intended to cover the application or implantation without departing from the scope of the invention.

### DESCRIPTIVE KEY

10 System for ordering a product and/or service
20, 20a, 20b Apparatuses/signal receiver-emitters
22 Casing
24, 24i, 24ii . . . and 24v Control mechanisms
25 Printed label or indicia
26 GPS receiver
27 Internal Memory
28 Processor
29 Transmitter
30 Host receiver
32 Receiving unit
33 Signal anomaly detection unit
34 Physical memory
36 Communication unit
40, 40a, 40b Fulfillment centres
A Amplitude
ds, ds1, ds2 Control or dispatch signals/commands
F Frequency
I Interrupting device
os1, os2 Predetermined order signals
Sₐ, S_{b}, S_{c} Satellites
ss1, ss2 . . . and ss6 Satellite GPS signals
T Time

1. A system for ordering a product and/or service, the system comprising:
a plurality of signal receiver-emitters, each of the signal receiver-emitters being configured to receive position and time stamp data from orbiting GPS satellites, and to transmit an associated predetermined signal having a unique signature, and comprising:
an interrupting device and associated control mechanism, the interrupting device being selectively operable via the control mechanism to effect at least one preselected signal anomaly in said associated predetermined signal, said at least one preselected signal anomaly comprising a preselected interruption of a predetermined duration or occurring in a predetermined pattern for a predetermined pattern duration;
a host receiver configured to receive a plurality of said associated predetermined signals, the host receiver comprising:
a communication unit;
a signal anomaly detection unit configured to detect said at least one preselected signal anomaly in said associated predetermined signals; and
a physical memory having stored thereon
reference data identifying the unique signature of each said associated predetermined signals,
customer information data correlated to each said unique signature of the associated predetermined signals, and
order information data correlated to said predetermined duration or predetermined pattern and pattern duration of the preselected interruption of each said at least one preselected signal anomaly in each said associated predetermined signals;
wherein the signal anomaly detection unit of the host receiver is operable to monitor said associated predetermined signals for each of the at least one preselected signal anomaly and, upon detecting said at least one preselected signal anomaly, to instruct the communication unit to output a control signal for initiating delivery of the product and/or service to a customer in accordance with said order information data.

2. The system of claim 1, wherein
at least one of said associated predetermined signals includes said position and time stamp data from the orbiting GPS satellites;
the host receiver further comprises a processing unit configured to analyze said position and time stamp data in order to determine location information of the signal receiver-emitters, the location information comprising GPS coordinates of said signal receiver-emitters;
the customer information data includes at least one of a customer name, a customer address and a customer vehicle identifier; and
the order information data includes instructions to deliver said product and/or service to the customer at one of the customer address or a customer vehicle located at said GPS coordinates, the customer vehicle being identifiable by way of the customer vehicle identifier.

3. The system of claim 1, wherein
at least one of said signal receiver-emitters further comprises a processor configured to analyze said position and time stamp data from the orbiting GPS satellites in order to determine location information of the signal receiver-emitters, the location information comprising GPS coordinates of said signal receiver-emitters;
at least one of said plurality of associated predetermined signals includes the location information;
the customer information data includes at least one of a customer name, a customer address and a customer vehicle identifier; and
the order information data includes instructions to deliver said product and/or service to the customer at one of the customer address or a customer vehicle located at said GPS coordinates, the customer vehicle being identifiable by way of the customer vehicle identifier.

4. The system of claim 1, wherein
at least one of said associated predetermined signals consists of a transient signal that is transmitted at predetermined equal intervals of time;
the reference data further includes data identifying said at least one associated predetermined signals by way of said predetermined equal intervals of time;
the preselected interruption of the at least one preselected signal anomaly in said at least one associated predetermined signals has the predetermined duration which spans at least two of said predetermined equal intervals of time, or occurs in the predetermined pattern that consists of extending said predetermined equal intervals of time by a preselected amount over the predetermined pattern duration; and
the order information data specifically correlates each of the predetermined duration or predetermined pattern and pattern duration of the at least one preselected signal anomaly in said at least one associated predetermined signals to a distinct order command which includes instructions to deliver said product and/or service in a manner and quantity that has been preselected by the customer, and to bill the customer for said product and/or service in accordance with pre-registered billing instructions.

5. The system of claim 1, wherein
at least one of said associated predetermined signals consists of a constant signal that when undisturbed is transmitted without any substantial interruptions;
the preselected interruption of the at least one preselected signal anomaly in said at least one associated predetermined signals has the predetermined duration or occurs in the predetermined pattern that consists of interrupting said constant signal in a predetermined pulsed pattern over the predetermined pattern duration; and
the order information data specifically correlates each of the predetermined duration or predetermined pattern and pattern duration of the at least one preselected signal anomaly in said at least one associated predetermined signals to a distinct order command which includes instructions to deliver said product and/or service in a manner and quantity that has been preselected by the customer, and to bill the customer for said product and/or service in accordance with pre-registered billing instructions.

6. The system of claim 1, wherein
the interrupting device is further configured, when activated via the control mechanism, to repeat said at least one preselected signal anomaly in said associated predetermined signal a preselected number of times and over a preselected period of time; and
the signal anomaly detection unit of the host receiver is further configured to ignore any duplicate detections of said at least one preselected signal anomaly in said associated predetermined signal which occurs in a predetermined window of time, so as to prevent any unwanted duplication in customer orders.

7. The system of claim 6, wherein
upon detecting a first occurrence of said at least one preselected signal anomaly in any said predetermined window of time by the signal anomaly detection unit, the communication unit is configured to assign an order number to said control signal, wherein the order number increases by a factor of 1 each time a further occurrence of said at least one preselected signal anomaly is detected in a new said predetermined window of time;
the customer information data further includes at least one of a customer e-mail address and a customer phone number; and
the control signal further initiates immediate delivery of an order confirmation receipt, which includes said order number, to the customer at said customer e-mail address or customer phone number.

8. The system of claim 2, wherein
the host receiver is geographically remote from at least one of said signal receiver-emitters; and
the control signal further initiates delivery of said product and/or service to the customer by transmitting a command for dispatch said product and/or service to one of a plurality of remote fulfilment centres, said one remote fulfilment centre being selected based on a variety of factors including current availability of said product and/or service at said one remote fulfilment centre and geographic proximity of said one remote fulfilment centre to said customer address or said GPS coordinates.

9. The system of claim 8, wherein
when the signal anomaly detection unit detects a first occurrence of said at least one preselected signal anomaly in any said predetermined window of time, the host receiver is configured to open a new ticket, corresponding to a new customer order;
upon receiving said command for dispatch the product and/or service, said one remote fulfilment centre transmits a confirmation receipt to the host receiver; and
upon receiving said confirmation receipt, the host receiver is further configured to mark the new ticket as having been completed.

10. The system of claim 1, wherein
at least one said associated predetermined signals comprises a digital signal and is transmittable over a cellular communications network.

11. The system of claim 1, wherein
at least one said associated predetermined signals is transmittable by radio.

12. The system of claim 1, wherein
the control mechanism is a push button.

13. The system of claim 1, wherein
the interrupting device is associated with at least one said control mechanism, the interrupting device being selectively operable via each said at least one control mechanism to effect a distinct said preselected signal anomaly in said associated predetermined signal; and
the order information data specifically correlates the predetermined duration or predetermined pattern and pattern duration of each said distinct preselected signal anomaly to a distinct said product and/or service for order.

14. The system of claim 1, wherein
at least one of said signal receiver-emitters is configured to transmit said associated predetermined signal over a wi-fi or bluetooth connection in a signal burst which includes the at least one preselected signal anomaly, when the interrupting device is activated via the control mechanism;
the customer information data includes at least one of a customer name and a customer address; and
the order information data specifically correlates the predetermined duration or predetermined pattern and pattern duration of the at least one preselected signal anomaly to a distinct said product and/or service for order, and includes instructions to deliver said distinct product and/or service to the customer address.

15. An apparatus for ordering a product and/or service, comprising:
a signal receiver-emitter configured to transmit periodic signal updates to a host server, the host server comprising a signal anomaly detection unit and being located at a remote fulfilment centre; and
an interrupting device having an associated control mechanism, the interrupting device being configured to interrupt said periodic signal updates for a predetermined duration or in a predetermined pattern over a predetermined pattern duration, when the control mechanism is activated by a user;
wherein the signal anomaly detection unit of the host server is configured to monitor the periodic signal updates for any interruptions in said periodic signal updates and to identify any said interruptions attributable to the interrupting device and occurring for the predetermined duration or in the predetermined pattern over the predetermined pattern duration; and
wherein data representing said interruptions occurring for the predetermined duration or in the predetermined pattern over the predetermined pattern duration has been pre-registered with the fulfilment center as identifying the product and/or service for order.

16. The apparatus of claim 15, wherein
the signal receiver-emitter is further configured to receive position and time stamp data from orbiting GPS satellites;
the apparatus further comprising
a processor configured to analyze said position and time stamp data to determine a location of the apparatus; wherein
the periodic signal updates include location information comprising said location and further include an identifier number of the apparatus which has been pre-registered with the fulfilment center as being associated with at least one of a customer name, a customer address and a customer vehicle identifier; and
when the signal anomaly detection unit identifies any said interruptions attributable to the interrupting device and occurring for the predetermined duration or in the predetermined pattern over the predetermined pattern duration, the host server is configured to output a control signal which includes
a command to deliver the product and/or service to at least one of the customer address or a customer vehicle located at said location of the apparatus, the customer vehicle being identifiable by way of the customer vehicle identifier, and
a command to bill the user for said product and/or service in accordance with billing instructions that have been pre-registered with the fulfillment centre.

17. The apparatus of claim 15, wherein
the signal receiver-emitter is further configured to receive position and time stamp data from orbiting GPS satellites;
the periodic signal updates include the position and time stamp data from the orbiting GPS satellites and further include an identifier number of the apparatus which has been pre-registered with the fulfilment center as being associated with at least one of a customer name, a customer address and a customer vehicle identifier;
the host server further comprises a processing unit configured to analyze the position and time stamp data to determine a location of the apparatus; and
when the signal anomaly detection unit identifies any said interruptions attributable to the interrupting device and occurring for the predetermined duration or in the predetermined pattern over the predetermined pattern duration, the host server is configured to output a control signal which includes
a command to deliver the product and/or service to at least one of the customer address or a customer vehicle located at said location of the apparatus, the customer vehicle being identifiable by way of the customer vehicle identifier, and
a command to bill the user for said product and/or service in accordance with billing instructions that have been pre-registered with the fulfillment centre.

18. The apparatus of claim 15, wherein
the periodic signal updates are transmitted at equal intervals lasting anywhere between 0.1 seconds and 5 hours; and
the interrupting device interrupts the periodic signal updates for the predetermined duration, the predetermined duration lasting anywhere between 0.2 seconds and 24 hours.

19. The apparatus of claim 15, wherein
the periodic signal updates are transmitted at equal intervals lasting anywhere between 0.1 seconds and 5 hours; and
the interrupting device interrupts the periodic signal updates in the predetermined pattern over the predetermined pattern duration, the predetermined pattern consisting of skipping a pre-selected number of said periodic signal updates over said predetermined pattern duration lasting anywhere between 0.2 seconds and 24 hours.

20. The apparatus of claim 15, wherein
when the control mechanism is activated by the user, the interrupting device is configured to repeat the interruption of said periodic signal updates a preselected number of times and over a preselected period of time; and
the signal anomaly detection unit of the host receiver is further configured to ignore any duplicate interruptions in said periodic signal anomalies, having the predetermined duration or the predetermined pattern and pattern duration, which occur in a predetermined window of time, so as to prevent any unwanted duplication in customer orders.
